(19) United States
(12) Patent Application Publication
(10) Pub. No.: US 2021/0345642 A1
(43) Pub. Date: Nov. 11, 2021

(54) SYSTEM AND METHOD FOR THE PREPARATION OF A TEXTURIZED NON-MEAT FOOD PRODUCT

(71) Applicant: SOCIETE DES PRODUITS NESTLE S.A., Vevey (CH)

(72) Inventors: Youcef Ait Bouziad, Echandens (CH); Jean-Marc Flick, Pomy (CH); Sheldon Fernandes, La Tour-de-Peilz (CH)

(21) Appl. No.: 17/274,493

(22) PCT Filed: Sep. 9, 2019
(86) PCT No.: PCT/EP2019/073935

§ 371 Date: Mar. 9, 2021

(30) Foreign Application Priority Data
Sep. 10, 2018 (EP) 18193495.1

(51) Int. Cl. A23J 3/22; A23J 3/14; A23J 3/26; A23P 30/20; A23J 3/24

(52) U.S. Cl. CPC A23J 3/227; A23J 3/14; A23J 3/24; A23P 30/20; A23J 3/26

(57) ABSTRACT

The invention relates to a food system (100) for preparing a texturized non-meat food product from a dehydrated powder product with the appearance and the texture of meat, the system comprising: —a processing chamber (10) receiving the dehydrated food product, hydrating and structuring at least part of it, and extruding it into a mass of a certain shape; —driving means (20) driving in rotation primary and secondary processing tools (110, 111) within the processing chamber (10) for hydrating, structuring and extruding the mass of food product; —a fluid reservoir (30) supplying a fluid into the processing chamber for hydrating the food product and creating a food mass; such that the processing chamber (10) comprises three sequential sub-chambers: —a mixing sub-chamber (12) comprising a primary processing tool (110) for hydrating, optionally heating, homogenizing and/or structuring the dehydrated food product or at least part of it into a food mass in batch mode; wherein the volume of the mixing sub-chamber (12) is larger than the volume of the food product prepared in it, so that the mixture of fluid and dehydrated food product is processed in free surface flow regime; —an extrusion sub-chamber (13) comprising a secondary processing tool (111) to optionally heat and expel the food mass from the mixing sub-chamber (12) and push it to the next sub-chamber in continuous mode, the extrusion sub-chamber (13) operating in pressurized flow regime, when activated, emptying at least part of the content of the mixing sub-chamber (12); —a cooled down die sub-chamber (14) to shape the food mass into a certain cross-sectional profile; whe the temperature in the three sequential sub-chambers (12, 13, 14) is independently controlled by distinct thermal sensing means arranged in each one of the sub-chambers, the sub-chambers (12, 13, 14) being further thermally isolated between them; and where the rotational speed and/or direction of the primary and secondary processing tools (110, 111) in the mixing sub-chamber (12) and in the extrusion sub-chamber (13), respectively, are independently controlled, so as to differently structure by heating and/or shear stress the food material in each of the sub-chambers (12, 13, 14). The invention further relates to a method for preparing a food product from a dehydrated powder product in a food system as the one described.

### FIELD OF THE INVENTION

The present invention relates to a food system for preparing a texturized non-meat food product from a dehydrated powder product having the appearance and the texture of meat. The invention further relates to a method for preparing a food product from a dehydrated powder product in such a food system.

### BACKGROUND OF THE INVENTION

Plant based meals and side dishes are estimated to be the biggest food trend in the coming decades. Meat-free and alternative protein products appeal to 14% to 25% of global consumers who are trying to eliminate or limit their meat intake due to ethical and/or health-related reasons. This includes the segment “Flexitarians” who focus on limiting their meat consumption. The present offer from the market is split between vegetable-based dishes and meat analogues. Vegetarian or vegetable dishes are those using commonly available vegetables as ingredients for cooking on a stove top and/or in an oven. Meat analogues are texturized plant-based proteins having the texture and sometimes also the taste of meat. Most of the current offering with good consumer acceptability and perception are sold chilled or frozen in supermarkets.

Dehydrated and some canned products exist in the market: however, both their taste and texture are generally perceived by consumers as being of a not high quality and are especially perceived as not fresh. Considering the growing time pressure that consumers face, there exists a persisting need for a solution that provides the best of both worlds without the need of complex preparation, particular skills or knowledge of ingredients.

The aim of the food system according to the present invention is to provide consumers with fresh chilled and/or frozen products using an ambient stored plant-based mixture that the consumer will use in the system to create delicious meals comfortably in their own kitchen. The plant-based mixture is stored ambient, therefore allowing flexibility of preparation and formats, and not requiring the occupation of precious refrigerator space. The combination of the plant-based mixture and a sauce or seasoning added afterwards allows a range of meal experiences based on the consumer's moods and tastes. The system also allows flexibility of use so that every consumer could choose to use only the texturizing part and complete the cooking of the dish on the stove top/oven, thereby using the texturized products as ingredients in their favorite home foods. There is also the option to let the system produce the complete meal by combining the extruded product with the chosen sauce and cooking it in a cooking unit.

The plant-based mixture is composed of plant proteins and/or plant extracts, starches, spices and flavoring giving ingredients. Some of the ingredients are chosen with the functionality to give meat-like textures when combined with the right sequence of mixing and heating. Others are intended to create unique formats, texture and taste of plant-based chunks which act as principal ingredients and protein source in the created meal. The composition considers not only the quantity of protein but also the quality in terms of amino acid profile and micronutrient content which is essential when moving to a plant-based diet. The success of such a system has a high potential to improve the quality of life of the consumer while having a positive environmental impact as well.

It is known in the state of the art, for example as per WO 2016/05940 A1, belonging to the applicant, a method to produce a non-meat food product by mixing dry ingredients comprising vegetable proteins with wet ingredients comprising at least one of water or oil to form a non-meat dough that will be later heated by pressure and further gradually cooled to form the final non-meat product. However, the process described in this document is for manufacturing a packaged non-meat food product industrially and cannot be applied for in-home smaller devices.

Also known in the art, from the applicant as well, is document WO 2016/150734 A1: a process for preparing a meat-analogue food product is described, comprising the steps of feeding an extruder barrel with water and plant protein, injecting liquid oil, fat or a combination of these, and finally extruding the mixture through a cooling die. As mentioned for the first document, the process described here is valid for manufacturing meat-analogues food products industrially, but would not be applicable for in-home smaller appliances.

As described, the known processes are continuous processes based on single screw or double screw extrusion, these screws being provided with different zones, specifically with different screw arrangements for each zone for each of the processes intended: transport, hydration, mixing, kneading, pressure increase and extrusion, etc. However, this structure is very long, it is therefore suitable for factories but not for in-home appliances. Not only the structures are too voluminous, but such continuous arrangements need time to stabilize the delivered food product, which leads to a lot of waste of material at the start of the process, something which is not suitable for home usages. As it will be further explained in detail in what follows, the system and method of the present invention change length of the machines by processing time: the system of the invention works preparing food in batches, not in continuous, so it can be prepared in a more reduced machine but needing a longer processing time (this would not be suitable for industrial applications, where no waiting time is acceptable).

Therefore, it is an object of the present invention to provide an in-home food system, not voluminous, able to deliver food meat-analogue products from dehydrated food powder products, convenient to use and versatile, allowing producing different meat-analogue products.

### SUMMARY OF THE INVENTION

According to a first aspect, the invention relates to a food system for preparing a texturized non-meat food product from a dehydrated powder product with the appearance and the texture of meat. The system of the invention comprises: a processing chamber receiving the dehydrated food product, hydrating and structuring at least part of it, and extruding it into a mass of a certain shape; driving means driving in rotation primary and secondary processing tools within the processing chamber for hydrating, structuring and extruding the mass of food product and a fluid reservoir supplying a fluid into the processing chamber for hydrating the food product and creating a food mass. In the system of the invention, the processing chamber comprises three sequential sub-chambers: a mixing sub-chamber comprising a primary processing tool for hydrating, optionally heating, homogenizing and/or structuring the dehydrated food product or at least part of it into a food mass in batch mode, the volume of the mixing sub-chamber being larger than the volume of the food product prepared in it, so that the mixture of fluid and dehydrated food product is processed in free surface flow regime; an extrusion sub-chamber comprising a secondary processing tool to optionally heat and expel the food mass from the mixing sub-chamber and push it to the next sub-chamber in continuous mode, the extrusion sub-chamber operating in pressurized flow regime, when activated, emptying at least part of the content of the mixing sub-chamber; a cooled down die sub-chamber to shape the food mass into a certain cross-sectional profile. The temperature in the three sequential sub-chambers is independently controlled by distinct thermal sensing means arranged in each one of the sub-chambers, the sub-chambers being further thermally isolated between them; the rotational speed and/or direction of the primary and secondary processing tools in the mixing sub-chamber and in the extrusion sub-chamber, respectively, being independently controlled, so as to differently structure by heating and/or shear stress the food material in each of the sub-chambers.

The food system of the invention further typically comprises a control unit governing one or a plurality of: fluid dosing from the fluid reservoir into the processing chamber; ratio of fluid to be mixed with the food product; speed and/or torque and/or rotational direction of the driving means; temperature in each of the three sequential sub-chambers; dosing of food product into the processing chamber; processing time.

Preferably, the control unit in the food system of the invention is connectable to a database providing recipe preparation information for the food product prepared in the system comprising preparation steps and/or triggering values, as a function of the dehydrated powder product.

According to a preferred embodiment, the driving means comprise a motor with electronic feedback of its current to determine the motor torque and thus the food product viscosity in the mixing sub-chamber in order to use this value as triggering value to expel the prepared food product mass into the extrusion sub-chamber.

Typically, the driving means in the food system of the invention comprise a motor with electronic feedback of its current to determine the motor torque and thus the food product shear stress in the extrusion sub-chamber in order to use this value to control the rotational speed of the secondary processing tool to increase or decrease the flow rate of the expelled food product mass into the die sub-chamber.

In the food system of the invention, typically the mixing sub-chamber and the extrusion sub-chamber are configured having substantially cylindrical shapes. Preferably, the diameter of the extrusion sub-chamber is smaller than the diameter of the mixing sub-chamber in order to limit the extrusion forces of the food product mass in the extrusion sub-chamber.

Preferably, the dehydrated powder product used in the food system of the invention is of vegetable protein composition. Typically, the vegetable protein composition comprises flavoring ingredients and it can also comprise a portion of starch and/or flour.

In the food system of the invention, the die sub-chamber preferably comprises a shaping element that is interchangeable in order to provide different shapes for the food product delivered. Further, the system typically comprises cutting means adjustable to provide different lengths of the food product.

According to a preferred embodiment, the primary and secondary processing tools in the food system of the invention are arranged along one single axis, the rotational speed and direction of which is adjustable, such that the primary processing tool arranged in the mixing sub-chamber comprises one or a plurality of mixing or kneading blades and at least a scrapping blade, and the secondary processing tool comprises a mono-screw extruder, helically shaped.

According to a second aspect, the invention further relates to a method for preparing a food product from a dehydrated powder product in a food system as the one described. The method of the invention comprises the following steps:
hydrating and mixing the dehydrated powder, optionally pre-heating the hydrated and structured food mass in the mixing sub-chamber (12) to a temperature below the structuration temperature of the proteins of the food mass;
heating the homogenized food mass in the extrusion sub-chamber to the temperature or over the temperature of phase-change for gelation and denaturation of the proteins of the food mass in the extrusion sub-chamber;
decreasing actively and/or passively the temperature of the proteins food mass to freeze the proteins' structure, form and shape along a certain direction, in the die sub-chamber.

Typically, in the method described above, the first step takes place while the primary and secondary processing tools rotate in a certain direction, while the second and third steps occur when the primary and secondary processing tools have reversed their direction of rotation.

Preferably, in the method of the invention, the heating means are activated or deactivated separately on each sub-chamber, depending if the product needs to be structured via heating and/or shearing.

According to a preferred embodiment, the temperature and/or viscosity of the food mass in each of the sub-chambers is independently controlled, such that the product does not go to the next sub-chamber until a certain value of temperature and/or viscosity has been reached in the previous sub-chamber.

Preferably, the preparation of the food product is done in batch mode in the mixing sub-chamber and sent in continuous from the extrusion sub-chamber to the die sub-chamber, in the method of the invention.

Typically, the temperature of the food mass in the mixing sub-chamber ranges from ambient temperature to 80° C., the temperature in the extrusion sub-chamber ranges from ambient to 150° C., and the temperature in the die sub-chamber ranges from ambient to 100° C.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIG. 1 shows a general overview of a processing chamber in a food system for preparing a texturized non-meat food product from a dehydrated powder product according to the invention.

FIG. 2 shows a more detailed view of the processing chamber in FIG. 1, showing the entry of the dehydrated food product into the said processing chamber.

FIG. 3 shows a side view of the processing chamber in a food system for preparing a texturized non-meat food product from a dehydrated powder product according to the invention.

FIG. 4 shows a frontal view of the processing chamber in a food system for preparing a texturized non-meat food product from a dehydrated powder product according to the invention, showing the funnel for the entry of the dehydrated powder product into the processing chamber.

FIG. 5 shows the configuration of the primary and secondary processing tools in the processing chamber used in a food system for preparing a texturized non-meat food product from a dehydrated powder product according to the invention.

FIG. 6 shows in detail the configuration of the primary and secondary processing tools of FIG. 5.

FIG. 7 shows a longitudinal cut view of the processing chamber, comprising primary and secondary processing tools, used in a food system for preparing a texturized non-meat food product from a dehydrated powder product according to the invention.

FIG. 8 shows a longitudinal cut view showing the precise arrangement of the primary and secondary processing tools in the processing chamber of a food system for preparing a texturized non-meat food product from a dehydrated powder product according to the invention.

FIG. 9 shows the general configuration of a food system for preparing a texturized non-meat food product from a dehydrated powder product according to the present invention.

FIG. 10 shows another overview of the food system shown in FIG. 9 for preparing a texturized non-meat food product from a dehydrated powder product according to the present invention.

FIG. 11 shows the configuration of the processing chamber, the driving means and thermal sensing means in a food system for preparing a texturized non-meat food product from a dehydrated powder product according to the present invention.

### DETAILED DESCRIPTION OF EXEMPLARY EMBODIMENTS

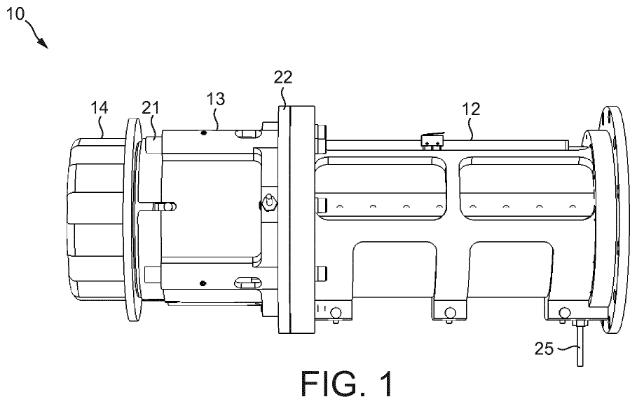

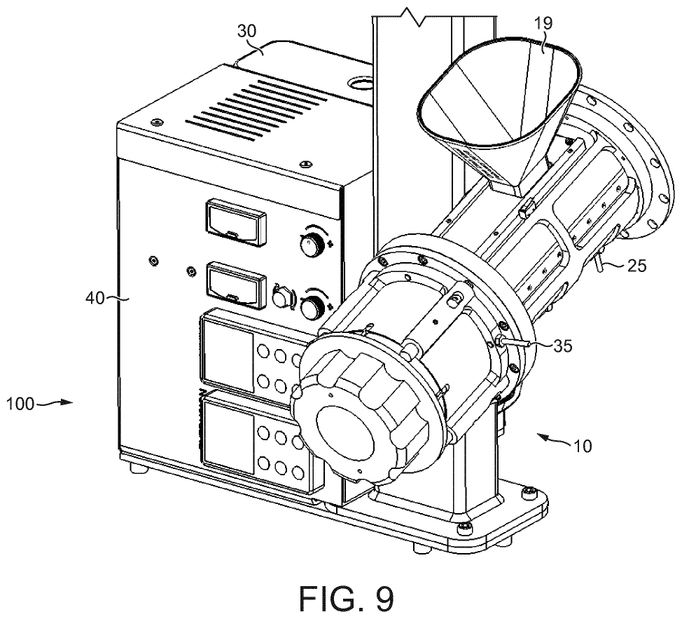

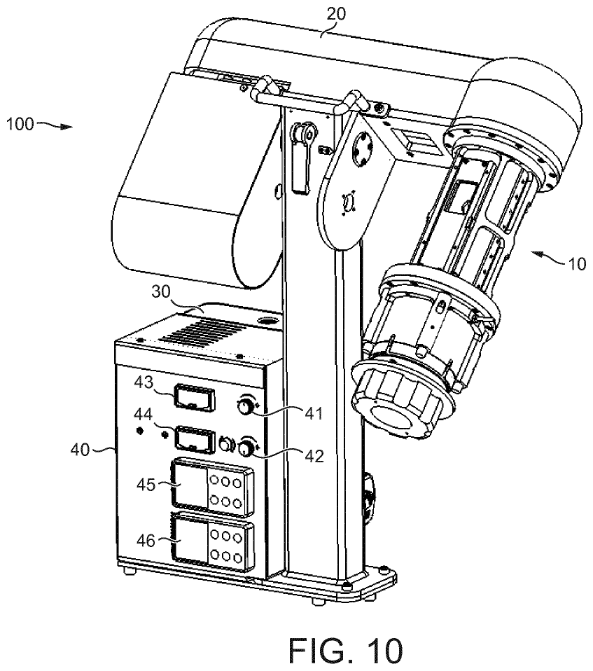

The object of the present invention is a food system 100 (as represented in FIGS. 9 and 10) for preparing a texturized non-meat food product from a dehydrated powder product with the appearance and the texture of meat. The system 100 comprises a processing chamber 10 as represented in FIG. 1: the processing chamber 10 receives the dehydrated food product (typically a powder), hydrates it with the addition of a fluid, (typically water), structures it and creates a homogenized food mass or mixture, and finally extrudes it into a food mass having a certain shape. For performing this, the processing chamber 10 comprises three sequential sub-chambers 12, 13 and 14, with specific configurations providing different processing to the food mass, as it will be further explained in detail.

Looking at FIG. 1, the processing chamber 10 is divided into a first mixing sub-chamber 12, a further extrusion sub-chamber 13 and a final cooled down die sub-chamber 14.

The first mixing sub-chamber 12 receives the dehydrated food product, adds a fluid (typically water) to it from a fluid reservoir in the system 100, and homogenizes or structures the food product into a food mass by rotation of a primary processing tool 110 inside this sub-chamber 12. Optionally, and depending on the food product and its processing, it can be further heated in the mixing sub-chamber 12: heating is done preferably by means of an electric resistance embedded in the walls of the mixing sub-chamber 12. The temperature of the food mass (heated or not) inside the mixing sub-chamber 12 is controlled by a thermal probe 25. The volume of the mixing sub-chamber 12 is larger than the volume of the food product prepared in it, so that the mixture of fluid and dehydrated food product is processed in free surface flow regime, such that the food mass inside is subjected to zero perpendicular normal stress and zero parallel shear stress.

It is essential in the system of the invention that it works in batch mode, meaning that there is a certain time needed to prepare the food mass in the mixing sub-chamber 12. Contrary to the processes in the known prior art, where the food products are manufactured in continuous, the process in the system of the invention needs time to prepare a certain quantity of product and to deliver the final texturized non-meat food product. The process requires longer time than an industrial process, but the system of the invention is much more compact and can therefore be used for in-home applications.

After the first mixing sub-chamber 12, the product mass goes into a further extrusion sub-chamber 13: the extrusion sub-chamber 13 is provided with a rotating secondary processing tool 111 inside, that pushes the food mass into the following sub-chamber, the die sub-chamber 14. Contrary to the mixing sub-chamber regime of free flow surface (not pressurized) the extrusion sub-chamber 14 works in a pressurized flow regime, where the food product mass inside of it is under pressure, and so is pushed in continuous mode into the following sub-chamber, the die sub-chamber 14. As such, when the extrusion sub-chamber 13 is activated, it empties in continuous all or at least part of the content of the mixing sub-chamber 12, then processes it under pressure and sends it in continuous to the die sub-chamber 14. The extrusion sub-chamber 13 can also optionally heat the product inside, typically by an electric resistance embedded in the wall of the said sub-chamber 13.

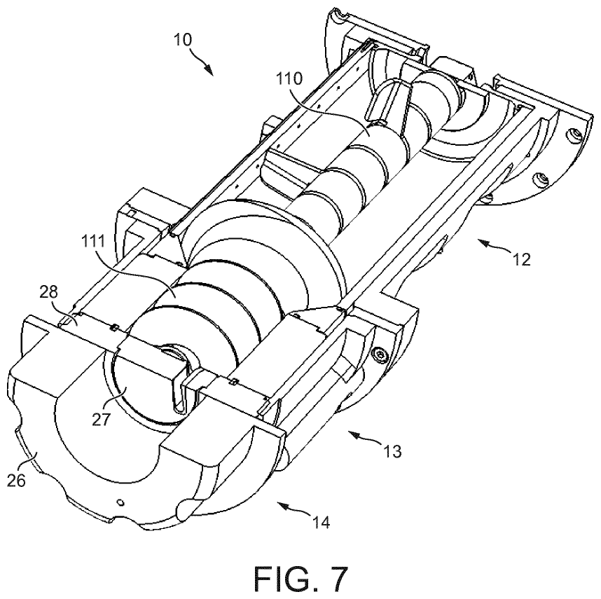

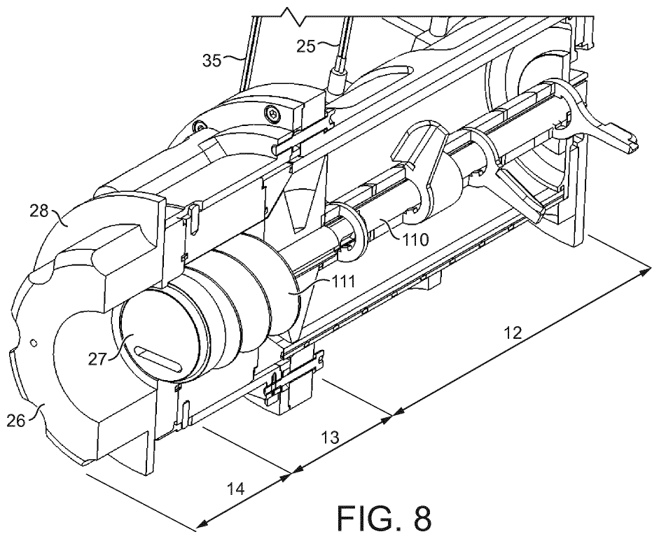

In the embodiment shown in the Figures attached (particularly in FIGS. 7 and 8), what we call “activation” of the extrusion sub-chamber 13 is done by reversing the rotational direction of the primary and secondary processing tools, 110 and 111. When the processing tools 110 and 111 rotate in the same direction (typically in counter clockwise direction) the food product or food product mass moves towards or stays in the mixing sub-chamber 12, so it is well mixed, homogenized and structured, continuously in batch mode: the extrusion sub-chamber 13 is not filled and no product is sent into this chamber, but rather remains in the mixing sub-chamber 12 (even if there will be some product in the extrusion sub-chamber 13, it will be sent to the mixing sub-chamber 12, by the design of the processing tools and the direction of rotation). When certain triggering values of the food product mass are reached in the mixing sub-chamber (typically temperature, viscosity, certain time elapsed, etc. as it will be further explained in more detail), the direction of rotation of the primary and secondary processing tools 110, 111 is reversed (typically, they start rotating in the clockwise direction): the product is then pushed from the mixing sub-chamber 12 and towards the extrusion sub-chamber 13, and from this sub-chamber 13 into the die sub-chamber 14, for delivery of the end product. It is then that the extrusion sub-chamber 13 is activated, according to the present invention. Therefore, the preparation of the food product is done in batch mode in the mixing sub-chamber 12 (requiring a certain preparation time) while the extrusion sub-chamber 13 is not activated. The process takes place in continuous mode in the extrusion and die sub-chambers 13 and 14, respectively, once the extrusion sub-chamber activates (the conveying of the food mass from the extrusion sub-chamber 13 into the die sub-chamber 14 is done in continuous mode).

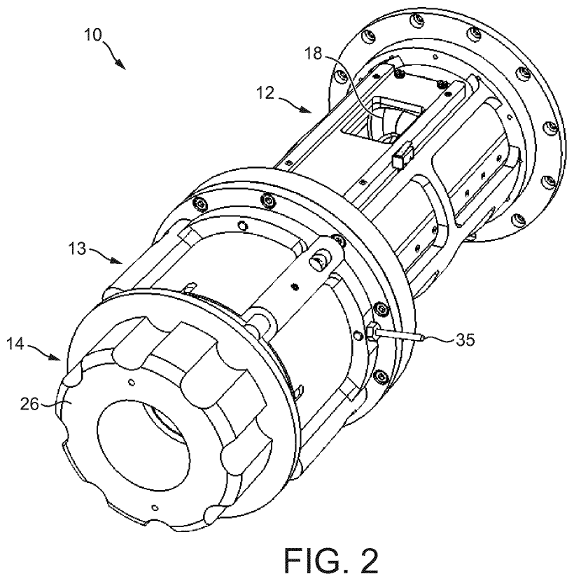

The final sub-chamber of the processing chamber 10 is the die sub-chamber 14, where the food product mass is shaped into a certain cross-sectional profile. The die sub-chamber 14 is cooled down either actively or passively. Passively means that the product is cooled down by passing through the die support mass 26, that is at ambient temperature, and is further cooled down when the product exits the die to the outside (see FIG. 2). Another alternative is that the die is actively cooled down, for example by a refrigerating fluid flowing around the wall of the die sub-chamber (not represented in the Figures).

In order to provide differential processing in each of the three sub-chambers 12, 13, 14 of the processing chamber 10, it is essential that the temperature in each of these chambers is controlled independently: in the configuration of the invention, distinct thermal sensing means are arranged in each one of these sub-chambers. In an exemplary embodiment represented in the attached Figures, there is a thermal probe 25 arranged in the mixing sub-chamber 12 and controlling the temperature of the product mass inside of it. Similarly, a distinct thermal probe 35 is arranged in the extrusion sub-chamber 13 to measure the temperature of the food mass inside this chamber. Another distinct thermal probe is arranged in the die sub-chamber 14 (though it is not shown in the Figures). In order to independently and properly control the temperature in each of the three sub-chambers, these sub-chambers are further isolated between them. Looking at FIG. 1, thermal insulating means 22 are provided between the mixing and the extrusion sub-chambers, 12 and 13. Similarly, thermal insulating means 21 are also provided between the extrusion and the die sub-chambers, 13 and 14. When the die sub-chamber 14 is actively cooled down, there is a further probe (not shown in the Figures, though) that controls the temperature of the food product exiting the die.

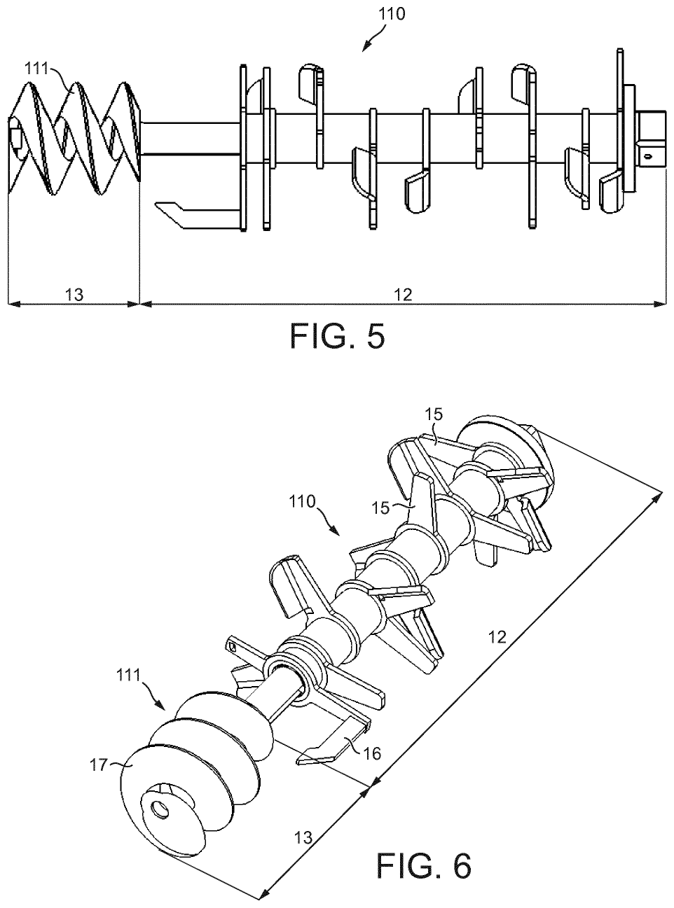

Moreover, the rotational speed and the direction of rotation of the primary and of the secondary processing tools, 110 and 111, respectively, in the respective mixing and extrusion sub-chambers, 12 and 13, are independently controlled: therefore, the food product mass in each of these sub-chambers can be structured differently, by heating and/or by shear stress. FIGS. 5 and 6 represent a preferred embodiment of the primary and secondary processing tools, 110 and 111: both tools can be independently rotated, thus modifying the rotational speed and/or direction of each. The primary processing tool 110 is arranged inside the mixing sub-chamber 12

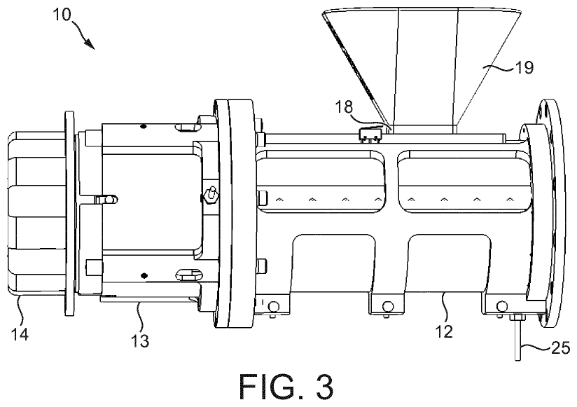

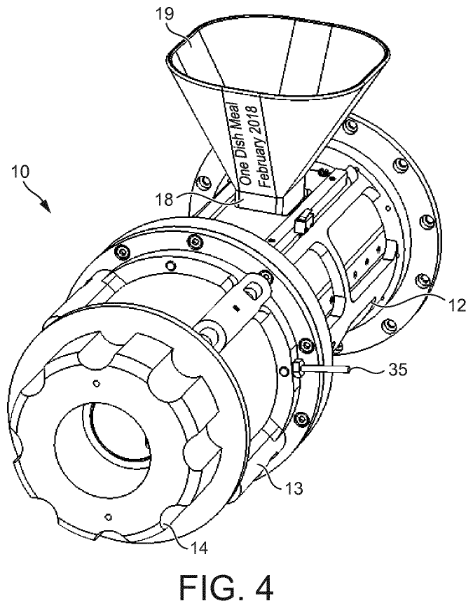

The dehydrated food product, typically powder, is introduced in the mixing sub-chamber 13 through a powder feeding aperture 18, as represented in FIG. 2. In order to facilitate the powder pouring, a funnel 19 is provided, the funnel ending in the aperture 18, as shown in FIG. 3 or 4.

The primary processing tool 110 comprises a plurality of mixing or kneading blades 15 and at least one scrapping blade 16. The blades 15, when rotating, mix and homogenize the food product mass. The scrapping blade 16 allows scrapping the mixture from the inner walls of the mixing sub-chamber 12, in order to create a mass of product that will be conveyed to the next sub-chamber, the extrusion sub-chamber 13. Inside the extrusion sub-chamber 13, the secondary processing tool 111 rotates and send in continuous the food product mass to the die sub-chamber 14. The secondary processing tool 111 typically comprises a single screw extruder 17 preferably with a helicoidal shape. The food mass in the extrusion sub-chamber 14 is subjected to pressure and sent to the next sub-chamber for being shaped in the die 27.

FIG. 7 shows a more detailed view of the primary and secondary processing tools 110, 11 arranged in the processing chamber 10, and also the configuration of the die sub-chamber 14, comprising the die 27, shaping the product mass into a certain cross-sectional profile, mounted on a die support 28, and then comprising a die support mass 26 for the passive cooling. FIG. 8 shows a detailed view of the arrangement of the primary and secondary processing tools 110, 111 in the chamber 10.

The die sub-chamber 14 comprises a shaping element that is interchangeable in order to provide different shapes for the food product delivered. Cutting means, adjustable to provide different lengths of the food product, are further provided at the exit of the die sub-chamber 14 (not represented in the Figures).

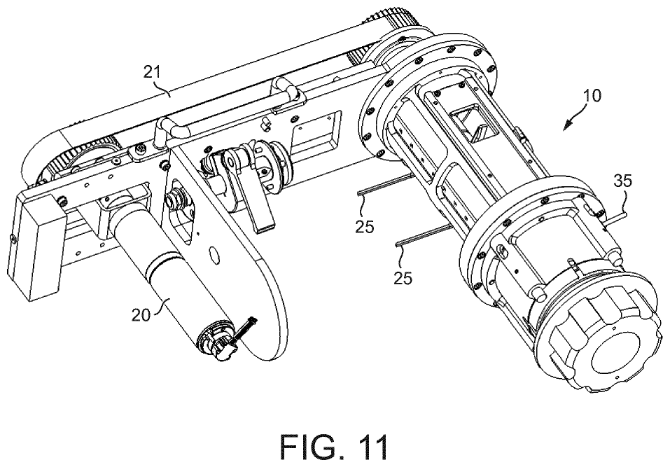

Looking at FIG. 10, a food processing system 100 is shown, comprising the processing chamber 10 as already explained and driving means 20 configured to drive in rotation the primary and secondary processing tools 110 and 111 within the processing chamber 10. Typically, the driving means 20 comprise a motor 20 moving a gear that is connected to a belt 21 that therefore drives a second gear directly driving in rotation the primary and secondary processing tools 110 and 111. FIG. 11 shows the configuration of the driving means connected to the processing chamber 10. FIG. 9 shows a further component of the food processing system 100 of the invention, further comprising a control unit 40 and a fluid reservoir 30. The fluid reservoir is preferably a water reservoir, and it delivers automatically, and according to the product prepared in the processing chamber 10, the quantity of water needed for the mixture, to hydrate the food product and create a food mass.

FIGS. 9 and 10 show the control unit 40 in the food system 100 of the invention, which controls the preparation of the food product. Preferably, the control unit, as represented schematically in FIG. 10, comprises, among others: a water dosing control 41, controlling the dosed quantity of water in the mixing sub-chamber 12, and a water dosing feedback 43 managing the ratio of water mixed with the food product with respect to the powder dosed; the control of the dosing of food product into the processing chamber 10 (particularly, into the mixing sub-chamber 12); motor rotation speed control and motor torque 42; the feedback control 44 of the motor speed and torque; temperature control 45 in the mixing sub-chamber 12 and temperature control 46 in the extrusion sub-chamber 13; processing time.

In the system of the invention, there is provided electronic feedback of the motor current to the control unit in order to determine the motor torque and thus be able to know the food product viscosity in the mixing sub-chamber 12: this value is used as triggering value to expel the prepared food product mass from the mixing sub-chamber 12 and into the extrusion sub-chamber 13. Furthermore, electronic feedback of the motor current is provided in the system too, to determine the motor torque and thus the food product shear stress in the extrusion sub-chamber 13 in order to use this value to control the rotational speed of the secondary processing tool 111 in the extrusion sub-chamber 13 to increase or decrease the flow rate of the expelled food product mass into the die sub-chamber 14.

Depending on the type of food product processed and on the recipe, the parameters are different and so the control unit 40 manages the product processing accordingly. Preferably, the control unit 40 is connectable to a database providing recipe preparation information for the food product prepared in the system comprising preparation steps and/or triggering values, as a function of the dehydrated powder product (powder) introduced.

Preferably, the mixing sub-chamber 12 and the extrusion sub-chamber 13 are configured having substantially cylindrical shapes. The diameter of the extrusion sub-chamber 13 is smaller than the diameter of the mixing sub-chamber 12 in order to limit the extrusion forces of the food product mass in the extrusion sub-chamber 13; the extrusion process generates a certain pressure in the food mass in the extrusion sub-chamber 13, function of a given rotation speed and a given viscosity of the product.

The dehydrated powder product introduced in the mixing sub-chamber 12 can be of vegetable protein composition, comprising a portion of starch and/or flour, and can further comprise flavoring ingredients. The dehydrated powder product can be provided in a cartridge or recipient that will be poured through the funnel 19 and into the aperture 18. When provided in a cartridge or recipient, it will typically comprise identification means that will be read by reading means in the system: processing parameters will be then sent to the control unit so the process is managed according to these. Another alternative is that the consumer enters manually the recipe number or code reported in the powder pack or cartridge or recipient, via an interface on the system or smartphone. Another alternative is that the consumer directly pours the powder product desired into the mixing sub-chamber 13.

Another option is to add into the mixing sub-chamber 12 an already pre-mixed mixture (processed and prepared outside the system 100): this way, the batch mode and the extra timing needed for processing will be reduced significantly. Yet another option of the system of the invention is to process a certain food mass in the mixing sub-chamber 12, and leave it there until the moment when it will be processed in the extrusion and die sub-chambers 13, 14, also with the aim of limiting the overall processing time in the system. It is therefore clear that there are two processes in the processing chamber 10, conceptually different: a batch mode processing of the food mass in the mixing sub-chamber 12, with the processing tools rotating in a certain direction, and a continuous mode of processing and sending the prepared mass from the extrusion into the die sub-chamber, 13 and 14 respectively, when the processing tools have reversed their direction of rotation.

According to a second aspect, the invention also relates to a method for preparing a food product from a dehydrated powder product in a food system 100 as the one described. The method of the invention comprises the following steps:
hydrating and mixing the dehydrated powder, optionally pre-heating the hydrated and structured food mass in the mixing sub-chamber 12; the mixture is preheated to a temperature below the structuration temperature of the proteins of the food mass, this being done by the processing of the mass through the primary processing tool 110, and the temperature can optionally be increased, if needed, by heating means on the said sub-chamber 12;
the homogenized food mass in the extrusion sub-chamber 13 is heated to the temperature or over the temperature of the phase-change for gelation and denaturation of the proteins of the food mass in the extrusion sub-chamber 13, either by the processing of the mass through the secondary processing tool 111 or, in case the temperature has to be increased, by heating means on the said sub-chamber 13;
decreasing actively and/or passively the temperature of the proteins food mass to freeze the proteins' structure, form and shape along a certain direction, in the die sub-chamber 14.

In the method of the invention, the first step (hydrating and mixing the dehydrated powder and preparing the mixture in the mixing sub-chamber 12) takes place while the primary and secondary processing tools, 110 and 111, rotate in a certain direction (typically, in counter clockwise direction), the extrusion sub-chamber 13 and thus the die sub-chamber 14 not being activated. For the second and third steps (the food mass is processed in the extrusion sub-chamber 13 and then goes through the die sub-chamber 14 for shaping), these sub-chambers 13 and 14 are activated, the primary and secondary processing tools, 110 and 111, having reversed their direction of rotation into clockwise direction, typically.

In the method of the invention, and in order to independently process the food mass in each sub-chamber, heating means can be activated or deactivated separately on the mixing sub-chamber and/or on the extrusion sub-chamber, depending if the product needs to be structured via heating and/or shearing. Particularly, the temperature and the viscosity of the food mass in each of the sub-chambers 12, 13 and 14 is independently controlled, such that the product does not go to the next sub-chamber until a certain value of temperature and/or viscosity has been reached in the previous sub-chamber. The control unit receives feedback from the temperature probes and therefore manages the process accordingly, according to the recipe desired.

Method for preparing a food product according to any of claims 14-16 wherein the preparation of the food product is done in batch mode in the mixing sub-chamber 12, thus requiring a certain preparation time. When the food mass is ready, according to the desired parameters (typically temperature and speed and/or torque values of the primary processing tool 110), as managed by the control unit 40, it is sent to the next sub-chamber, the extrusion sub-chamber 13. There, the product is prepared under pressure, extruded, and once ready, as controlled by the control unit, typically receiving speed and torque values from the processing tool 111, it is sent in continuous into the die sub-chamber 14, for the final shaping and delivery.

Even when depending on the product type and characteristics, the temperature of the food mass in the mixing sub-chamber 12 ranges from ambient temperature to 80° C., the temperature in the extrusion sub-chamber 13 ranges from ambient to 150° C., and the temperature in the die sub-chamber 14 ranges from ambient to 100° C.

Although the present invention has been described with reference to preferred embodiments thereof, many modifications and alternations may be made by a person having ordinary skill in the art without departing from the scope of this invention which is defined by the appended claims.

1. Food system for preparing a texturized non-meat food product from a dehydrated powder product with the appearance and the texture of meat, the system comprising:
a processing chamber receiving the dehydrated food product, hydrating and structuring at least part of it, and extruding it into a mass of a certain shape;
a driving method driving in rotation primary and secondary processing tools within the processing chamber for hydrating, structuring and extruding the mass of food product;
a fluid reservoir supplying a fluid into the processing chamber for hydrating the food product and creating a food mass;
the processing chamber comprises three sequential sub-chambers:
a mixing sub-chamber comprising a primary processing tool for hydrating, optionally heating, homogenizing and/or structuring the dehydrated food product or at least part of it into a food mass in batch mode; wherein the volume of the mixing sub-chamber is larger than the volume of the food product prepared in it, so that the mixture of fluid and dehydrated food product is processed in free surface flow regime;
an extrusion sub-chamber comprising a secondary processing tool to optionally heat and expel the food mass from the mixing sub-chamber and push it to the next sub-chamber in continuous mode, the extrusion sub-chamber operating in pressurized flow regime, when activated, emptying at least part of the content of the mixing sub-chamber;
a cooled down die sub-chamber to shape the food mass into a certain cross-sectional profile;
the temperature in the three sequential sub-chambers is independently controlled by distinct thermal sensor arranged in each one of the sub-chambers, the sub-chambers being further thermally isolated between them;
and
wherein the rotational speed and/or direction of the primary and secondary processing tools in the mixing sub-chamber and in the extrusion sub-chamber, respectively, are independently controlled, so as to differently structure by heating and/or shear stress the food material in each of the sub-chambers.

2. Food system according to claim 1 further comprising a control unit governing one or a plurality of: fluid dosing from the fluid reservoir into the processing chamber; ratio of fluid to be mixed with the food product; speed and/or torque and/or rotational direction of the driving method; temperature in each of the three sequential sub-chambers; dosing of food product into the processing chamber; processing time.

3. Food system according to claim 2 wherein the control unit is connectable to a database providing recipe preparation information for the food product prepared in the system comprising preparation steps and/or triggering values, as a function of the dehydrated powder product.

4. Food system according to claim 1 wherein the driving method comprises a motor with electronic feedback of its current to determine the motor torque and thus the food product viscosity in the mixing sub-chamber in order to use this value as triggering value to expel the prepared food product mass into the extrusion sub-chamber.

5. Food system according to claim 1 wherein the driving method comprises a motor with electronic feedback of its current to determine the motor torque and thus the food product shear stress in the extrusion sub-chamber in order to use this value to control the rotational speed of the secondary processing tool to increase or decrease the flow rate of the expelled food product mass into the die sub-chamber.

6. Food system according to claim 1 wherein the mixing sub-chamber and the extrusion sub-chamber are configured having substantially cylindrical shapes.

7. Food system according to claim 6 wherein the diameter of the extrusion sub-chamber is smaller than the diameter of the mixing sub-chamber in order to limit the extrusion forces of the food product mass in the extrusion sub-chamber.

8. Food system according to claim 1 wherein the dehydrated powder product is of vegetable protein composition.

9. Food system according to claim 8 wherein the vegetable protein composition comprises flavouring ingredients.

10. Food system according to claim 8 wherein the vegetable protein composition comprises a portion of starch and/or flour.

11. Food system according to claim 1 wherein the die sub-chamber comprises a shaping element that is interchangeable in order to provide different shapes for the food product delivered.

12. Food system according to claim 1 further comprising cutting means adjustable to provide different lengths of the food product.

13. Food system according to claim 1 wherein the primary and secondary processing tools are arranged along one single axis, the rotational speed and direction of which is adjustable, such that the primary processing tool arranged in the mixing sub-chamber comprises one or a plurality of mixing or kneading blades and at least a scrapping blade, and the secondary processing tool comprises a mono-screw extruder, helically shaped.

14. Method for preparing a food product from a dehydrated powder product in a food system for preparing a texturized non-meat food product from a dehydrated powder product with the appearance and the texture of meat, the system comprising a processing chamber receiving the dehydrated food product, hydrating and structuring at least part of it, and extruding it into a mass of a certain shape, a driving method driving in rotation primary and secondary processing tools within the processing chamber for hydrating, structuring and extruding the mass of food product, a fluid reservoir supplying a fluid into the processing chamber for hydrating the food product and creating a food mass, the processing chamber comprises three sequential sub-chambers, a mixing sub-chamber comprising a primary processing tool for hydrating, optionally heating, homogenizing and/or structuring the dehydrated food product or at least part of it into a food mass in batch mode; wherein the volume of the mixing sub-chamber is larger than the volume of the food product prepared in it, so that the mixture of fluid and dehydrated food product is processed in free surface flow regime, an extrusion sub-chamber comprising a secondary processing tool to optionally heat and expel the food mass from the mixing sub-chamber and push it to the next sub-chamber in continuous mode, the extrusion sub-chamber operating in pressurized flow regime, when activated, emptying at least part of the content of the mixing sub-chamber, a cooled down die sub-chamber to shape the food mass into a certain cross-sectional profile, the temperature in the three sequential sub-chambers is independently controlled by distinct thermal sensor arranged in each one of the sub-chambers, the sub-chambers being further thermally isolated between them, and wherein the rotational speed and/or direction of the primary and secondary processing tools in the mixing sub-chamber and in the extrusion sub-chamber, respectively, are independently controlled, so as to differently structure by heating and/or shear stress the food material in each of the sub-chambers, the method comprising the following steps:
hydrating and mixing the dehydrated powder;
heating the homogenized food mass in the extrusion sub-chamber to the temperature or over the temperature of phase-change for gelation and denaturation of the proteins of the food mass in the extrusion sub-chamber; and
decreasing actively and/or passively the temperature of the proteins food mass to freeze the proteins' structure, form and shape along a certain direction, in the die sub-chamber.

15. Method for preparing a food product according to claim 14 wherein the first step takes place while the primary and secondary processing tools rotate in a certain direction, while the second and third steps occur when the primary and secondary processing tools have reversed their direction of rotation.

16. Method for preparing a food product according to claim 14 wherein the heating means are activated or deactivated separately on each sub-chamber, depending if the product needs to be structured via heating and/or shearing.

17. Method for preparing a food product according to claim 14 wherein the temperature and/or viscosity of the food mass in each of the sub-chambers is independently controlled.

18. Method for preparing a food product according to claim 14 wherein the preparation of the food product is done in batch mode in the mixing sub-chamber and sent in continuous rom the extrusion sub-chamber to the die sub-chamber.

19. Method for preparing a food product according to claim 14 wherein the temperature of the food mass in the mixing sub-chamber ranges from ambient temperature to 80° C., the temperature in the extrusion sub-chamber ranges from ambient to 150° C., and the temperature in the die sub-chamber ranges from ambient to 100° C.
